(19) United States
(12) Patent Application Publication
(10) Pub. No.: US 2013/0268358 A1
(43) Pub. Date: Oct. 10, 2013

(54) METHODS AND APPARATUS FOR OFFERING SERVICES FOR SALE OVER THE INTERNET

(71) Applicant: David HAAS, Warrington, PA (US)

(72) Inventor: David HAAS, Warrington, PA (US)

(21) Appl. No.: 13/857,018

(22) Filed: Apr. 4, 2013

Related U.S. Application Data
(60) Provisional application No. 61/620,150, filed on Apr. 4, 2012.
(60) Provisional application No. 61/711,283, filed on Oct. 9, 2012.

(51) Int. Cl. G06Q 30/02

(52) U.S. Cl. CPC G06Q 30/0255
USPC 705/14.53

(57) ABSTRACT

International travel preparation systems are provided. Methods of offering services for sale over the internet are provided. Services may include travel preparation services. Travel preparation services may include travel and medical insurance, passport services and medical preparation services. Customized travel medical reports used by medical professionals and snippet reports used by consumers and retailers to educate travelers on the perils of international travel designed to protect consumers and generate sales opportunities for retailers who service those travelers are provided. Computer readable mediums having processor-executable instructions stored thereon which, when executed by at least one processor, cause the at least one processor to perform a method of offering services for sale over the internet are provided.

This application claims the benefit of U.S. Provisional Application No. 61/620,150, filed Apr. 4, 2012, and U.S. Provisional Application No. 61/711,283, filed Oct. 9, 2012, which are incorporated herein by reference as if fully set forth.

### BACKGROUND

Each year approximately 61 million U.S. travelers visit foreign destinations. When traveling to a foreign country, after deciding on a destination to travel to, travelers will usually purchase a ticket and obtain a passport or visa. Some travelers will also take steps to ensure that they are medically prepared for travel to that destination as well.

The CDC estimates that approximately 50% of all travelers contract an illness as a direct result of their travel (such illnesses may range in severity from travelers' diarrhea to serious disease or death). Most, if not all, of these ailments are preventable, yet less than 30% of travelers receive routine vaccinations, preventative drugs, proper medical guidance or other treatment prior to their trip.

### SUMMARY

In an aspect, the invention relates to a travel preparation system. The travel preparation system may include a database including a plurality of user data and a plurality of travel preparation data, a communication interface that receives data from at least one user device, the received data including user travel related data, and a processor that accesses the database based on the received data and identifies travel services to offer including at least one of passport services or medical preparation services. The identified travel services are provided to the at least one user device via the communication interface.

In an aspect, the invention relates to a method of offering services for sale over the Internet. The method includes receiving via a communication interface travel related data and user data, identifying user travel services including at least one of passport services or medical preparation services based on the travel related data and the user data using a processor, and retrieving by a processor information from a database about travel services associated with the travel related data and user data.

In an aspect, the invention relates to a computer readable medium. The computer readable medium having processor-executable instructions stored thereon which, when executed by at least one processor, cause the at least one processor to perform a method. The method includes receiving travel related data and user data, identifying user travel services including at least one of passport services or medical preparation services based on the travel related data and the user data, and retrieving information about travel services associated with the travel related data and user data.

### BRIEF DESCRIPTION OF THE DRAWINGS

A more detailed understanding may be had from the following description, given by way of example in conjunction with the accompanying drawings, wherein:

FIG. 1 illustrates a travel preparation system according to an aspect of the present invention;

FIG. 2 illustrates a method of offering travel services that may be implemented on the system of FIG. 1;

FIG. 3 illustrates a block diagram of a tablet computing device that may be used to implement features described herein;

FIG. 4 illustrates a block diagram of an example work flow;

FIG. 5 illustrates a diagram of an example Internet search result for an example Internet search for “passport photos”;

FIG. 6 illustrates a diagram of an example website advertising in-store only passport photo services;

FIG. 7 illustrates a diagram of an example GUI including a grid system that may be displayed on a display of mobile or other electronic device pursuant to an example passport photo application;

FIG. 8 illustrates a diagram of an example GUI providing suggested passport photo services for the traveler to select from;

FIG. 9 illustrates an example method of using the travel preparation system;

FIG. 10 illustrates an example method of using the travel preparation system;

FIG. 11 illustrates an example method of using the travel preparation system;

FIG. 12 illustrates an example application including the travel preparation system;

FIG. 13 illustrates an example user data field within an example application including the travel preparation system;

FIG. 14 illustrates an example report within an example application including the travel preparation system;

FIG. 15 illustrates an example search field with an example application including the travel preparation system;

FIG. 16 illustrates example search results from the example search field in FIG. 15;

FIG. 17 illustrates an example user data input field in an example application including the travel preparation system;

FIG. 18 illustrates a block diagram of an example work flow;

FIGS. 19A-19J illustrate a diagram of an example snippet report;

FIG. 20 illustrates a flow diagram of an example method of offering services for sale over the Internet;

FIG. 21A illustrates a flow diagram of another example method of offering services for sale over the Internet;

FIG. 21B illustrates a flow diagram including an example variation of the method of offering services for sale over the Internet of FIG. 21A; and

FIG. 22 illustrates a diagram of an example user interface for entering information via an Internet website.

### DETAILED DESCRIPTION

It is to be understood that the figures and descriptions of the present invention have been simplified to illustrate elements that are relevant for a clear understanding of the present invention, while eliminating, for the purpose of clarity, many other elements found in mobile applications and other computer programs, and systems including, but not limited to, internet sales and applications. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Certain terminology is used in the following description for convenience only and is not limiting. The words “a” and “one,” as used in the claims and in the corresponding portions of the specification, are defined as including one or more of the referenced item unless specifically stated otherwise. The phrase “at least one” followed by a list of two or more items, such as “A, B, or C,” means any individual one of A, B or C as well as any combination thereof.

Described herein is a real-time, web-based and mobile-based system for offering international travel related services and a method of using the system, which enables a user to prepare for travel. Preparing for travel may include obtaining a passport, insurance and receiving proper destination specific preventative medical care.

Currently, obtaining a passport may be a tedious and relatively expensive task for a traveler. Not only does the traveler need to apply for the passport, but he or she usually also needs to go to a different location to have a passport photo taken. Further, because passport photos are required to be formatted in a particular manner (e.g., size and background restrictions), a traveler cannot easily use a photo he or she has already taken or simply go to any photography studio to have a passport photo taken. Instead, the traveler must go to a designated passport photo location to have a properly formatted passport photo taken. Further, travelers may have need for other travel-related or photo-related services at the time of, or shortly after, deciding on a travel destination. This invention allows the traveler to take the photo from their mobile device and deliver it electronically to a convenient photo processing location (like a pharmacy) near their home or work location.

Reasons that travelers may not obtain routine vaccinations, preventative drugs, proper medical guidance or other treatment prior to their trip may include, for example, lack of timely information, the traditional doctor patient process and the elective nature of such medical care. Methods and apparatus, including, for example, software and platforms, are described herein that may streamline the process for the consumer, dramatically increasing the percentage of travelers who obtain proper medical care prior to their trip. In addition to reducing or eliminating contraction of illnesses that are directly related to travel, increasing the percentage of travelers receiving treatment may also eliminate billions of dollars in health care costs and lost productivity and generate billions of dollars in revenue for drug companies.

Methods and apparatus, including, for example, software and platforms, are described herein that may streamline the process of obtaining a passport for the consumer and enable companies in the travel and photo industries to market to consumers at the point of making the decision to travel. In particular, methods and apparatus are described that may enable a traveler to easily take a properly formatted passport photo of him or herself and upload the photo to a suggested service who may print and provide it to the traveler based on their preferred location of pick-up using location based technology (where the consumer is or wants to be and where the closest provider is (e.g., by mail or in-store pickup). In an embodiment, the traveler may be provided with a discount for taking the photo him or herself and/or in exchange for the opportunity for advertising other travel-related products and/or services. At the point that the user begins the passport photo process, companies and/or services may connect with the traveler regarding other opportunities such as hotel and ticket reservations, travel insurance, medical treatment (e.g. vaccines) via direct contact (calls, e-mails, etc.), targeted Internet advertising, etc. Leads may also be generated and sent to travel and medical-related companies, who may choose to contact the traveler with other travel-related advertisements and/or offers. In other words, travelers may be connected electronically (e.g., via web cam, computer camera, iPad, iPhone, Android device, Mobile Application, etc.) to a convenient delivery point (e.g., a pharmacy, a grocery store, etc.) via a location based database and software, which will determine the most convenient location for the traveler, while integrating advertisements and/or travel medical reports to initiate additional transactions via links, lead generation, advertising, etc.

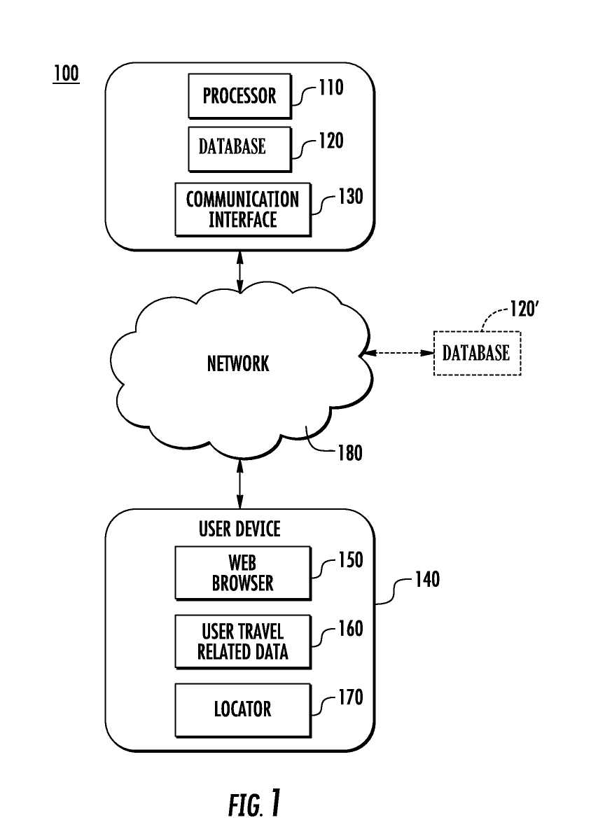

Referring to FIG. 1, a travel preparation system 100 of the present invention is illustrated with a processor 110, a database 120, a communication interface 130, a user device 140 including a web browser 150 or other means of accessing network 180, and user travel related data 160, interconnected via a network 180. Travel preparation system 100 may optionally include a locator 170 located within user device 140. A user may include a consumer interested in travel, searching for travel or booking travel. Using user device 140, user may access system 100 using web browser 150. Web browser 150 may communicate with system 100 using network 170. User travel related data 160 may be passed from user device 140 to communication interface 130 using network 180. Processor 110 may gather user information and travel preparation data from database 120. Processor 110 may retrieve travel services information from database 120 in response to user travel related data 160. Using database 120, user related travel data 160 and the information contained therein, the user may be offered travel services.

System 100 as described herein may be implemented as a stand-alone executable, as a web application, as a rich Internet application a mobile application, and/or as any other appropriate type of application. System 100 may be implemented using technologies that include modern programming languages such as C and/or C++, a development framework such as Adobe Air, and/or any other appropriate technology.

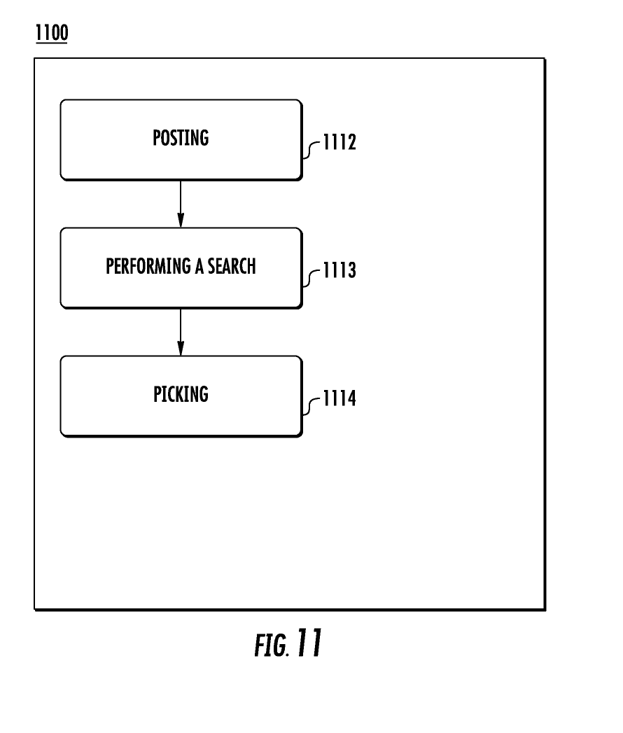

Alternatively, system 100 may be implemented as a native application. A native application may include an application program developed for use on any user device contained herein. A native application may be installed directly on any user device contained herein. An example application is illustrated in FIG. 12.

System 100 may include a web widget or a mobile widget. A widget may include a small application with limited functionality. A widget may be installed and executed within a web page. A widget may include a transient or auxiliary application, meaning that it may occupy a portion of a webpage. A widget may display information from another website. The widget may be accessed and downloaded by a user. The widget may be embedded in a third party site. The third party site may include a retail provider such as a pharmacy or a travel services website. The third party site may include a travel related website or mobile application. The widget may include simple registration such as inserting user data and user travel related data. The widget may be implemented in any system, application or method herein.

Database 120 may be spread across one or more computer-readable media, and may be or include one or more relational databases, hierarchical databases, object-oriented databases, one or more flat files, one or more spreadsheets, and/or one or more structured files. Database 120 may be managed by one or more database management systems, which may be based on a technology such as Microsoft SQL Server, MySQL, PostgreSQL, Oracle Relational Database Management System (RDBMS), a NoSQL database technology, and/or any other appropriate technology. Database 120 may include a number of different types of data that are used by system 100. Database 120 may include a plurality of user data. Database 120 may include a database of all registered users. Database 120 may store user data. User data may describe the user accounts. This data may include, for each account, data such as the name of the account owner, address, location, an email address, phone number, billing information such as credit card number, bank account information and billing address, shipping information and user preferences related to travel related services. The data may also include health information of the user including age, medical history, medications, height/weight, vaccination records, hospital records, mental illnesses and disorders. The data may also include categories of interest and social network information. Database 120 includes a unique user ID for each account profile.

Database 120 may learn the preferences and other information regarding a user based on the user's interaction with system 100, including, but not limited to, purchases, searches and requests for more information that the user makes with system 100. Database 120 may gather information regarding a user based on the user's social networking profiles including but not limited to Facebook, Twitter, Foursquare, and LinkedIn. Database 120 may learn the preferences and other information of a user based on the user's answers to web-based polls. Database 120 may learn the preferences and other information of a user based on the user's recommendations online and on social networking profiles. Database 120 may gather information about potential new users through referrals from existing system 100 users.

Database 120 may include travel preparation data. Travel preparation data may include all travel services offered using system 100. Travel services may include passport services and medical preparation services. Passport services may include services for obtaining/renewing passports and expediting passport services. This may include a passport photo provider. The passport photo provider may be an online provider or a traditional provider location. Medical preparation services may include vaccination requirements, medical guidance, diseases, preventative medications and medical providers of the foregoing based on locales or areas of the world, for example. Medical preparation services may include generating a medical report or a snippet report. Travel services may also include travel insurance services, travel reservation services and travel guide services. Travel insurance services may include travel insurance including medical insurance and evacuation insurance, as well as travel insurance providers. Travel reservation services may include hotels, and transportation including but not limited to flights, cars and trains. Travel guide services may include information about a travel destination, for example tourist activities and providers of travel guides. Each of the travel services may be categorized by travel destination, travel date and provider locations.

Communication interface 130 may include any software and/or hardware configured in the context of client-server architecture. For example, communication interface 130 may be a computer program running to serve the requests of other programs. Thus, communication interface 130 performs some computational task on behalf of other requestors. These requestors may run on the same computer or connect through network 180. Communication interface 130 may be a physical computer or other computer hardware system dedicated to running one or more services to serve the needs of users of the other computers on network 180. Communication interface 130 may provide services across network 180, to multiple user devices 140. Virtually every action taken by an ordinary Internet user requires one or more interactions with one or more communication interface 130. While communication interface 130 is discussed as a singular communication interface, communication interface 130 may take the form of multiple communication interfaces. The communication interface 130 may be, for example, a communications port, a wired transceiver, a wireless transceiver, and/or a network card. The communication interface 130 may be capable of communicating using technologies such as Ethernet, fiber optics, microwave, xDSL (Digital Subscriber Line), Wireless Local Area Network (WLAN) technology, wireless cellular technology, and/or any other appropriate technology.

User device 140 may be any portable personal electronic device capable of accessing network 180. User device 140 may be a laptop, a tablet computer, a desktop computer, a personal digital assistant or a mobile phone. For example, user device 140 may be a smartphone. User device 140 may also include a plurality of user devices.

System 100 may include a storefront device to access the system in addition to or in the alternative to, a user device. A storefront device may include a laptop, a tablet computer, a desktop computer, or an interactive kiosk. Such a device may be located in a retail location. The interactive kiosk may be a self-serve kiosk. System 100 may be accessed and interacted with via the storefront device. That is, a user may go to a pharmacy and use an on-site kiosk to access system 100 to receive travel preparation services.

Communication between user device 140 and system 100 takes place via network 180. Network 180 may include one or more private and/or public networks, and may include the Internet. Network 180 may include wired and/or wireless networks (such as cellular and/or wireless local area network (WLAN) networks), and may be based on technology such as Internet Protocol (IP). Network 180 may be a collection of hardware components and computers interconnected by communication channels that allow sharing of resources and information. Where at least one process in one device is able to send/receive data to/from at least one process residing in a remote device, then the two devices are in a network. Network 180 may be classified according to a wide variety of characteristics such as the medium used to transport the data, communications protocol used, scale, topology, and organizational scope. Communications protocols define the rules and data formats for exchanging information in network 180, and provide the basis for network programming. Well-known communication protocols are Ethernet, hardware and Link Layer standard that is ubiquitous in local area networks, and the Internet Protocol Suite, which defines a set of protocols for internet working, i.e. for data communication between multiple networks, as well as host-to-host data transfer, and application-specific data transmission formats.

A user may access system 100 from user device 140 by using web browser 150 such as by inputting a web page specific to system 100. Web browser 150 may be any standard browser that is capable of accessing the World Wide Web. Web browser 150 may include Firefox, Google Chrome, Internet Explorer, Opera and Safari, for example. A web browser may be any software application for retrieving, presenting, and traversing information resources on the World Wide Web, such as by identifying an information resource by a Uniform Resource Identifier (URI). A web browser can also be defined as an application software or program designed to enable users to access, retrieve and view documents and other resources on the Internet. Although browsers are primarily intended to access the World Wide Web, a browser can also be used to access information provided by web servers in private networks or files in file systems.

System 100 may be accessed via a mobile application. A mobile application may include application software developed for mobile phones and tablet computers. The mobile application may be downloaded to user device 140 by accessing a web page specific to system 100 or accessing a mobile application store, using web browser 150. As a mobile application, a direct connection may be created between user device 140 and system 100 to enable the application to efficiently operate.

User travel related data 160 may include data such as travel destination and travel date as well as itinerary and other plans or activities during travel.

Locator 170 may be a device that may provide information about the location of user device 140. Locator 170 may be used to notify system 100 of user's current location. Locator 170 may include or identify the user's current longitude and latitude and/or Global Positioning System (GPS) location. Locator 170 may be provided user generated location information. Locator 170 may acquire location information from a third party application such as Foursquare® or Facebook® Check In. Locator 170 may acquire location information by continuous location monitoring. Locator 170 may operate through the positioning system of mobile device 140, or may alternatively be an individual unit capable of providing the location of user device 140. Locator 170 may operate using GPS, triangulation, and the like. Locator 170 may record locations over a period of time and/or may be used to provide instantaneous location information.

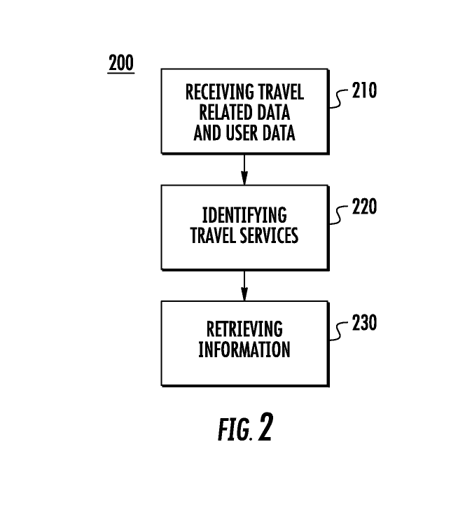

Referring to FIG. 2, method 200 of offering services over the internet using system 100 is illustrated. Method 200 may include the steps of receiving via the communication interface travel related data and user data 210, identifying the user travel services including at least one of passport services or medical preparation services based on the travel related data and the user related data using the processor 220 and retrieving information from the database about travel services associated with the travel related data and user data 230.

Receiving travel related data and user data at step 210 may be initiated by the user entering data into a form in the application or on a website. Receiving 210 may occur by being directed e-mail or other information and/or accessing data via an application or website.

Identifying user travel services at step 220 may include identifying at least one of passport services, medical preparation services, travel insurance services, travel reservation services, travel guide services and providers of each, based on at least one of user travel destination, user travel dates, user activities user location, and user preferences. Identifying 220 may be achieved by accessing a database with system 100 or remote thereto.

Retrieving information at step 230 may include displaying at least one of passport services, medical preparation services, travel insurance services, travel reservation services, travel guide services and providers of each. Retrieving information at step 230 may include generating a medical report or a snippet report.

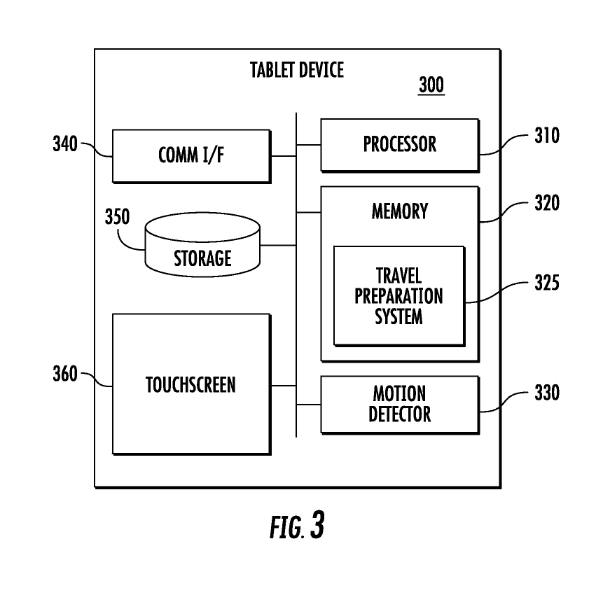

FIG. 3 is a block diagram of a tablet computing device 300 that may be used to implement features described herein. The tablet computing device includes a processor 310, a memory device 320, a communication interface 340, a data storage device 350, a touchscreen display 360, and a motion detector 330. These components may be connected via a system in the tablet computing device, and/or via other appropriate interfaces within the tablet computing device.

The memory device 320 may be or include a device such as a Dynamic Random Access Memory (D-RAM), Static RAM (S-RAM), or other RAM or a flash memory. As shown in FIG. 3, the application, or appropriate web browser 325, is loaded into the memory device.

The data storage device 350 may be or include a hard disk, a magneto-optical medium, an optical medium such as a CD-ROM, a digital versatile disk (DVDs), or Blu-Ray disc (BD), or other type of device for electronic data storage. The data storage device 350 may store instructions that define the application, and/or data that is used by the application.

The communication interface 340 may be, for example, a communications port, a wired transceiver, a wireless transceiver, and/or a network card. The communication interface 340 may be capable of communicating using technologies such as Ethernet, fiber optics, microwave, xDSL (Digital Subscriber Line), Wireless Local Area Network (WLAN) technology, wireless cellular technology, and/or any other appropriate technology.

The touchscreen display 360 may be based on one or more technologies such as resistive touchscreen technology, surface acoustic wave technology, surface capacitave technology, projected capacitave technology, and/or any other appropriate touchscreen technology.

When the touchscreen display 360 receives data that indicates user input, the touchscreen display 360 may provide the data to the application. Alternatively or additionally, when the motion detector detects motion, the motion detector may provide the corresponding motion or location information to the application.

As illustrated in FIG. 3, the application is loaded into the memory device. Although actions are described herein as being performed by the application, this is done for ease of description and it should be understood that these actions are actually performed by the processor (in conjunction with the persistent storage device, network interface, memory, and/or peripheral device interface) in the tablet computing device, according to instructions defined in the application or via third party server accessed by the application. Alternatively or additionally, the memory device and/or the data storage device in the tablet computing device may store instructions which, when executed by the processor, cause the processor to perform any feature or any combination of features described above as performed by the application. Alternatively or additionally, the memory device and/or the data storage device in the tablet computing device may store instructions which, when executed by the processor, cause the processor to perform (in conjunction with the memory device, communication interface, data storage device, touchscreen display, and/or motion detector) any feature or any combination of features described above as performed by the application.

The tablet computing device shown in FIG. 3 may be, for example, an Apple iPad, or any other appropriate tablet computing device. The application may run on an operating system such as iOS, Android, Linux, Windows, and/or any other appropriate operating system.

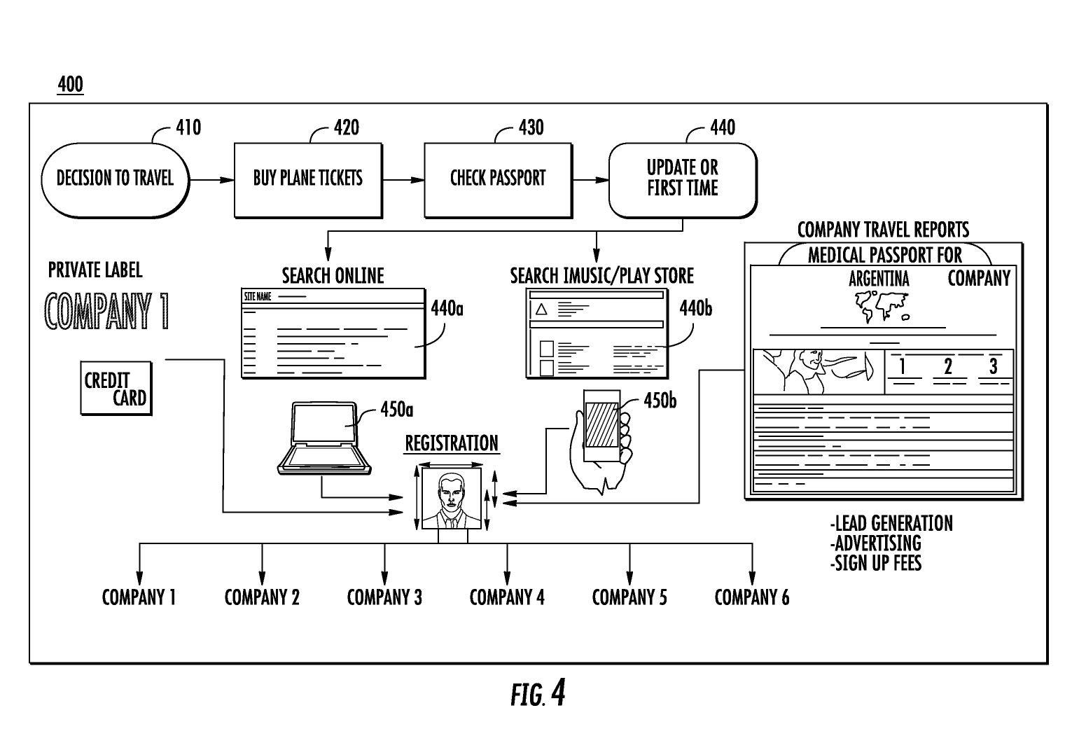

FIG. 4 illustrates a block diagram of an example work flow 400. In the illustrated work flow, a traveler may make a decision to travel 410, including, for example, deciding on a destination to travel to. The traveler may then purchase plane tickets 420 and, if the traveler has chosen to travel to a foreign destination, the traveler must check his or her passport 430 determine whether he or she needs to obtain or update a passport 440. If the traveler determines that he or she needs to obtain or update a passport 440, the traveler may access the Internet and perform a search for terms related to passports 440a (e.g., enter “passport service” or “passport photos” into an Internet search engine). In another embodiment, the traveler may perform a similar search at an application site 440b, such as I-Tunes or Google Play. As a result of either search, the traveler may download the application or receive a link to passport photo application that the traveler may download 450a and/or run 450b, for example, on his or her phone, laptop or other electronic device equipped with a camera (e.g., an iPhone® or Android® powered mobile device).

In another embodiment, the traveler may link to the passport photo application from another Internet website, application or service. For example, the traveler may receive the link in an advertisement from a travel report, an online ticket booking engine or website of a company that offers passport photo services.

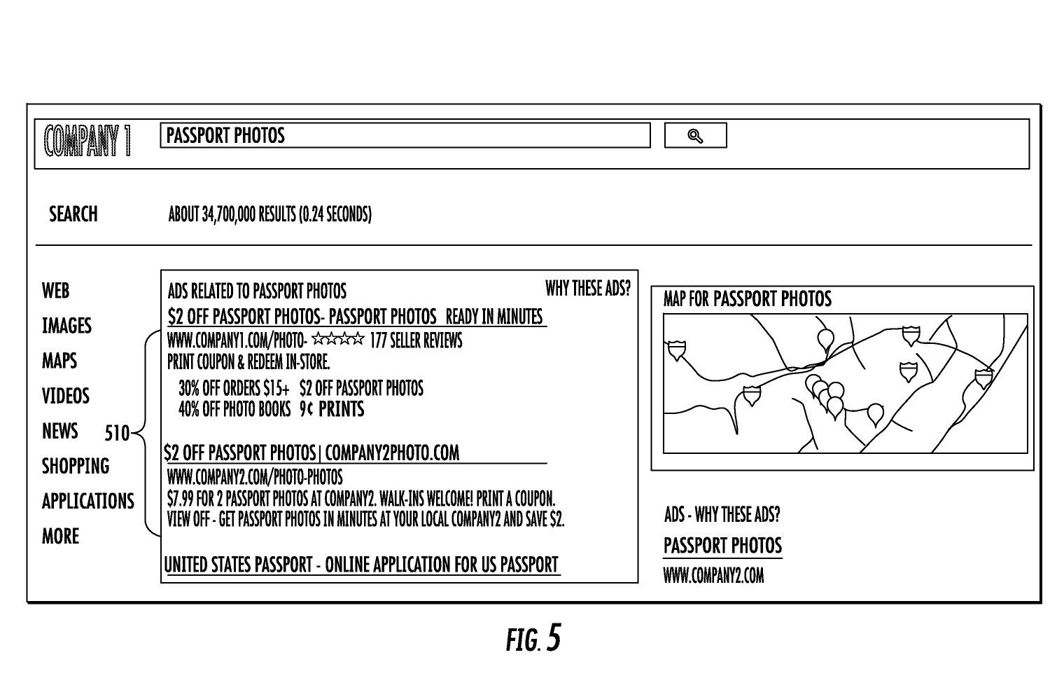

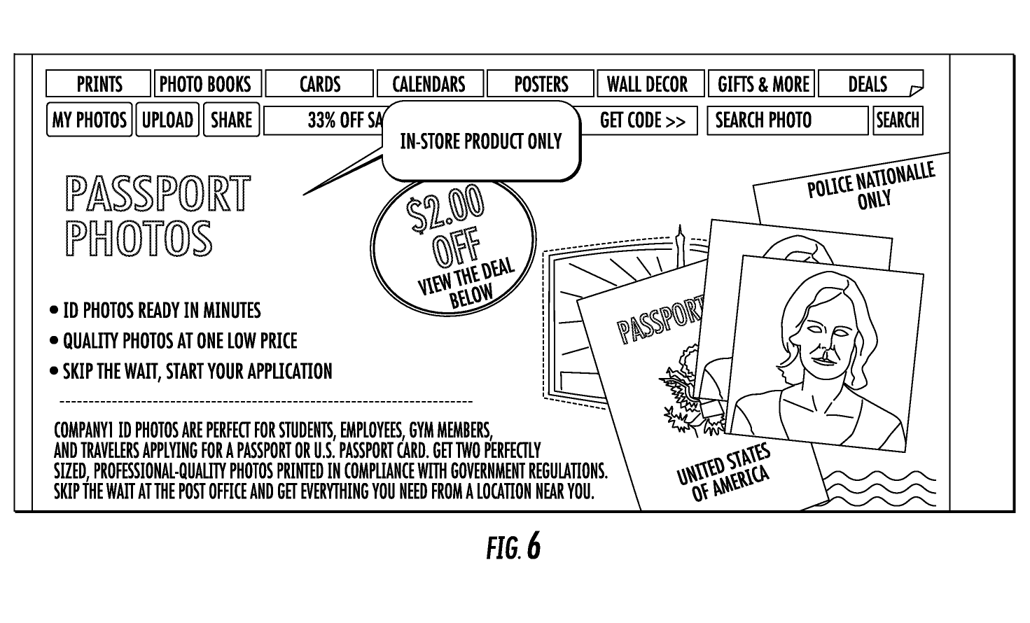

FIG. 5 illustrates a diagram of example Internet search results for an example Internet search for “passport photos.” The example search results 510 provide links to websites that a traveler may use to obtain a passport and/or passport photo. Some links may be for services where a user must go to a store and have the photo taken there. An example diagram of a website advertising in-store only services is illustrated in FIG. 6. Another link may be for an application to apply for a passport. Another link may be for downloading and/or running a passport photo application. The search results 510 may also include advertisements, such as for discounted passport photo services (e.g., from services that will print and provide a passport photo to a traveler when the traveler has taken the photo him or herself) and other travel-related services.

In an embodiment, the passport photo application allows a traveler to take a photo that is sized and formatted pursuant to passport photo requirements on a mobile or other electronic device and have it delivered electronically to “partner” photo processor who will print and or mail the photos to the most convenient location. (e.g., at home or work).

When the traveler clicks on a link to run or download the passport photo application, a link may appear prompting the user to get a passport photo now. Once the application launches, a graphic user interface (GUI) including grid system may be displayed on a display on the traveler's mobile or other electronic device. The grid system comports to U.S. passport photo requirements and may also provide recommendations for acceptable photos.

FIG. 7 illustrates a diagram of an example GUI including a grid system that may be displayed on a display of mobile device pursuant to a passport photo application. The GUI includes a view finder window that is sized pursuant to passport photo regulations (e.g., a 2 inch by 2 inch window). A mobile phone user, for example, may set his or her phone to the front facing camera and move the phone around until his or her face appears within the viewfinder window. The grid system may include other markers indicating, for example, where in the window the user's face must appear and where his or her eyes should appear and the recommended background color. In the illustrated example, the user's face must appear within a particular area of the window and be approximately 1 inch to 1 and ⅜ inches in length. Also in the illustrated example, the user's eyes should appear approximately 1 and ⅛ to 1 and ⅜ inches from the bottom of the window. Once the user's face is properly aligned within the viewfinder window the application may change colors and or the user may press a button to capture the photo. In another embodiment, a traveler may use a rear-facing camera on an electronic device and have another person capture the photo for him or her.

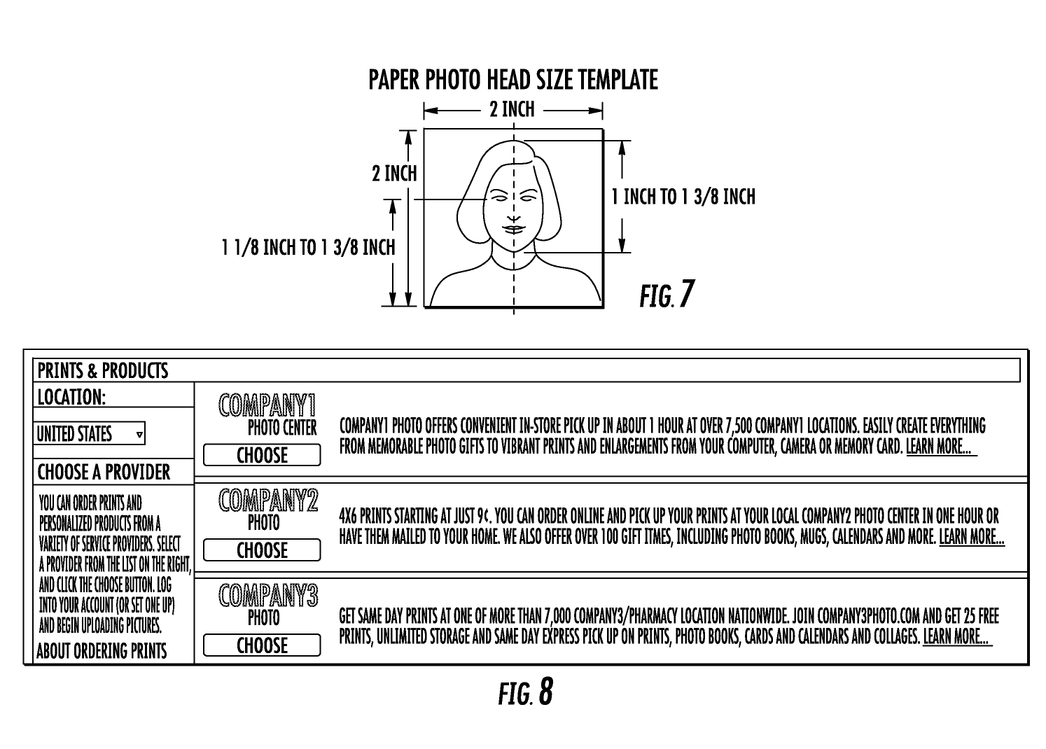

The passport photo application may then be directed via the mobile or other electronic device to save the captured photo. The passport photo services application may then send the photo to be printed. The user may then choose where he or she would like to pick up the photo or whether he or she would like the photo mailed to him or her. Suggested locations or services may be suggested by the passport photo application to the user, such as pharmacies and supermarkets that offer passport photo services. These suggestions may be based on the user's current location or work location either found electronically (e.g., Location services on a smartphone) or based on the users input (zip code for home or work). In an embodiment, suggested locations may be based on geographic distance from the traveler. FIG. 8 is a diagram of an example GUI providing suggested passport photo services for the traveler to select from.

In an embodiment, a traveler may register with an application server and/or one of the providers of passport photo services. To do so, the traveler may be prompted to enter his or her name, address, zip code, telephone number, e-mail address, destination, date of travel, etc. If the traveler will be charged for the photo, the traveler may also be prompted to enter his or her credit card information. In an embodiment, a mobile device such as an iPhone® or Android® smart phone may capture some or all of this information. In another embodiment, the user may not need to expressly enter his or her geographic location. Instead, the application may access the user's current location (e.g., via GPS data provided via the phone's GPS unit).

Once the user chooses a passport photo service (e.g., by clicking one of the links provided in a GUI such as the one illustrated in FIG. 8), the user may then choose a pick up destination. In an embodiment, suggestions for pickup locations may be provided, for example, based on the traveler's address and zip code. The user may then be prompted to sign up for a new photo service or to sign in to an existing photo service. The photo that was previously saved on the user's electronic device may then be sent electronically to the closest destination. In an embodiment, the photo may be automatically sent. Alternatively, the user may select the photo to be sent. In an embodiment (e.g., for iPhone®, Android®, iPad, etc.), a service may negotiate a deal with partners to integrate the passport photo transfer.

The passport photo application may also provide to the user's electronic device to display, or send to the user, targeted advertising, including, for example, links to other services and reports. Such advertisements may be related to, for example, travel insurance, travel supplies (e.g., travel kits and drugs), medical safety and security travel reports, travel services such as tickets, hotels and tours and other photo services and activities in the locale. In an embodiment, leads or information about the user and the upcoming travel for advertisements may be sent to travel partners. The travel partners may then e-mail, mail or call the traveler with their own advertising.

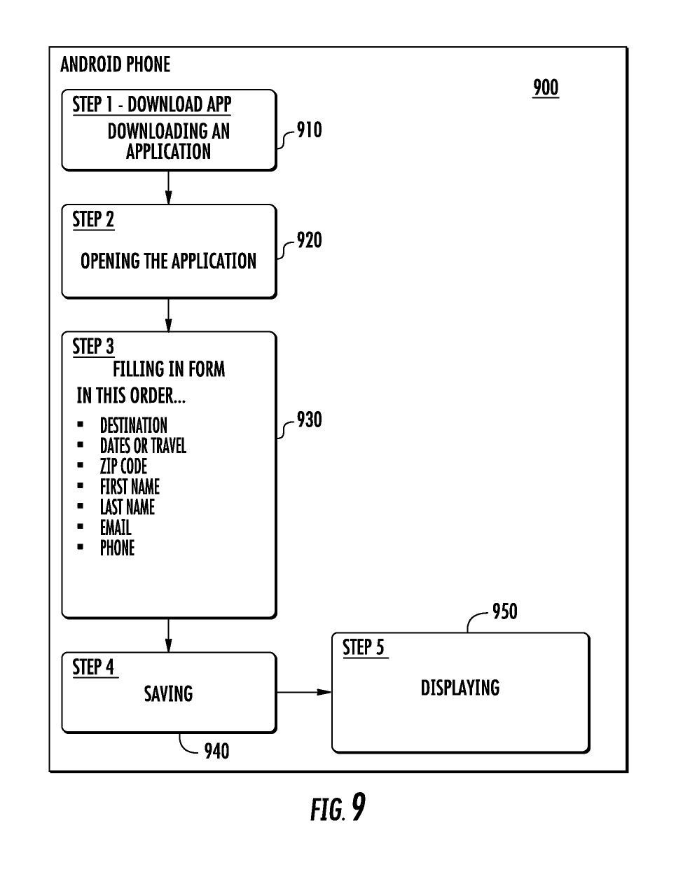

FIG. 9 illustrates an example method 900 of using the travel preparation system. Method 900 may include downloading an application 910, opening the application 920, filling in form 930, saving 940 and displaying 950.

Downloading the application at step 910 may include accessing and downloading the application 910 from an Application store or from an internet website. Downloading the application 910 may include saving the application on the user device and/or creating access to the downloaded application 910 on the user device.

Opening the application at step 920 may include accessing the application on user device. Opening the application 920 may include clicking a link or button to launch the application. Opening the application 920 may include clicking on a My Info button. The My Info tab in the application may open automatically the first time the application is opened. The My Info tab may open when the user clicks anywhere in the application.

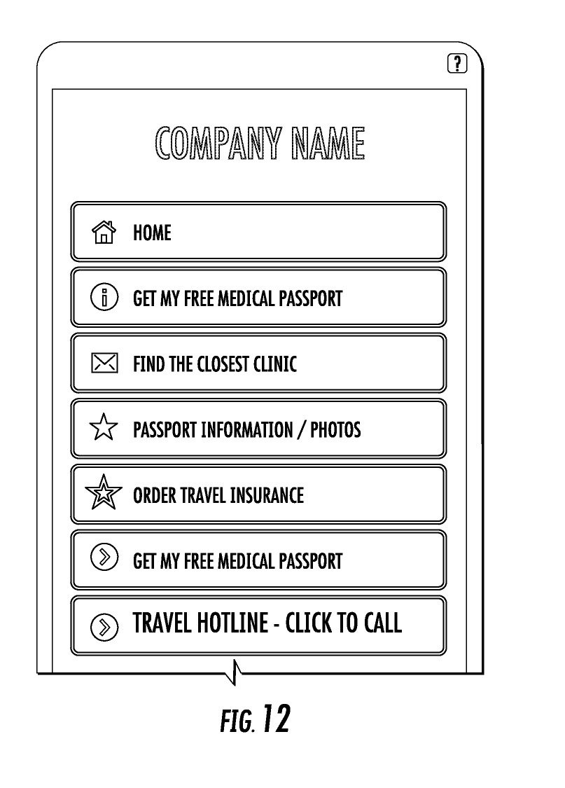

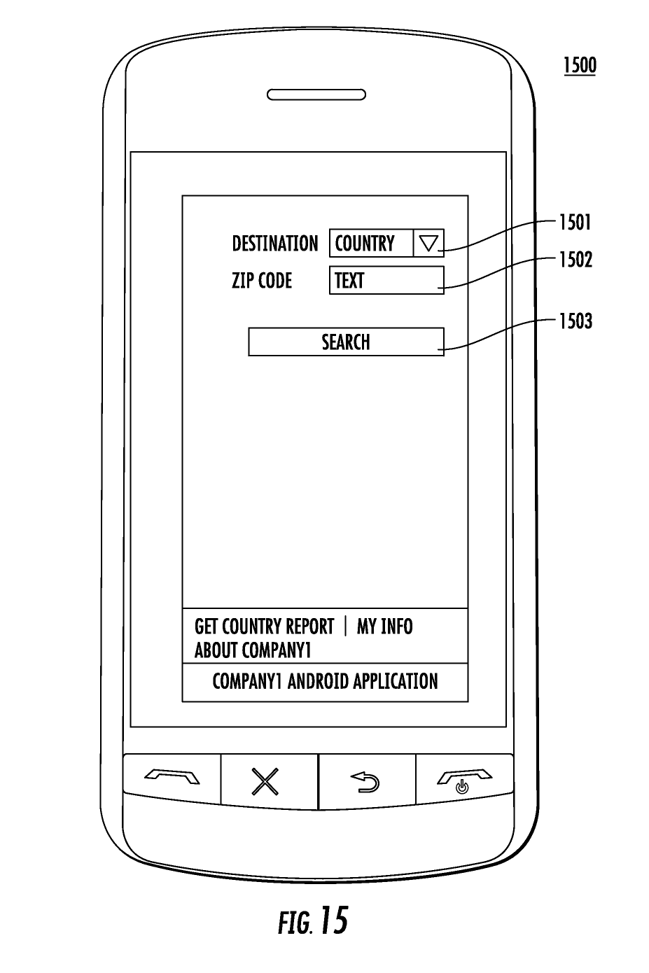

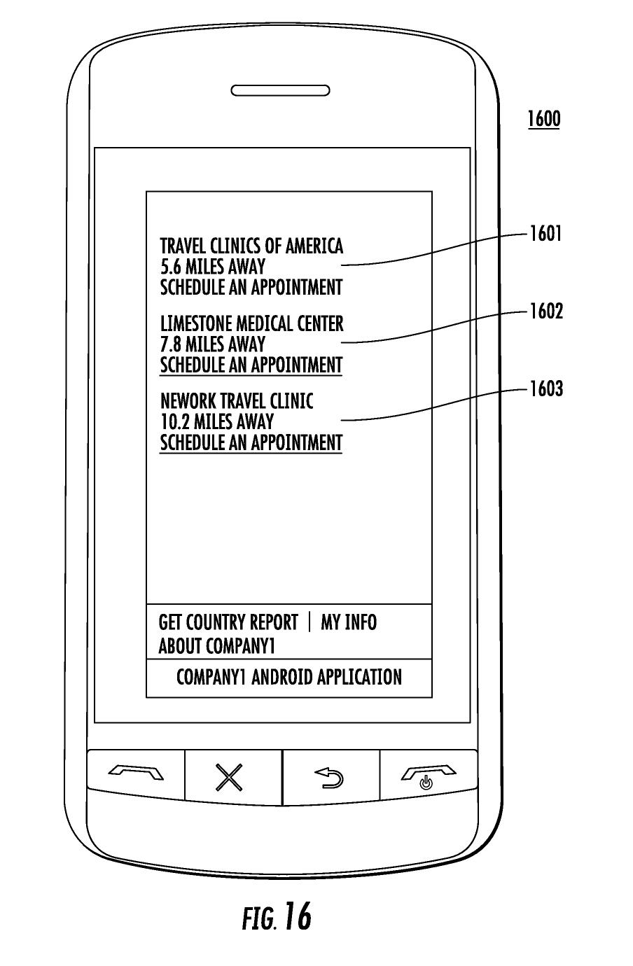

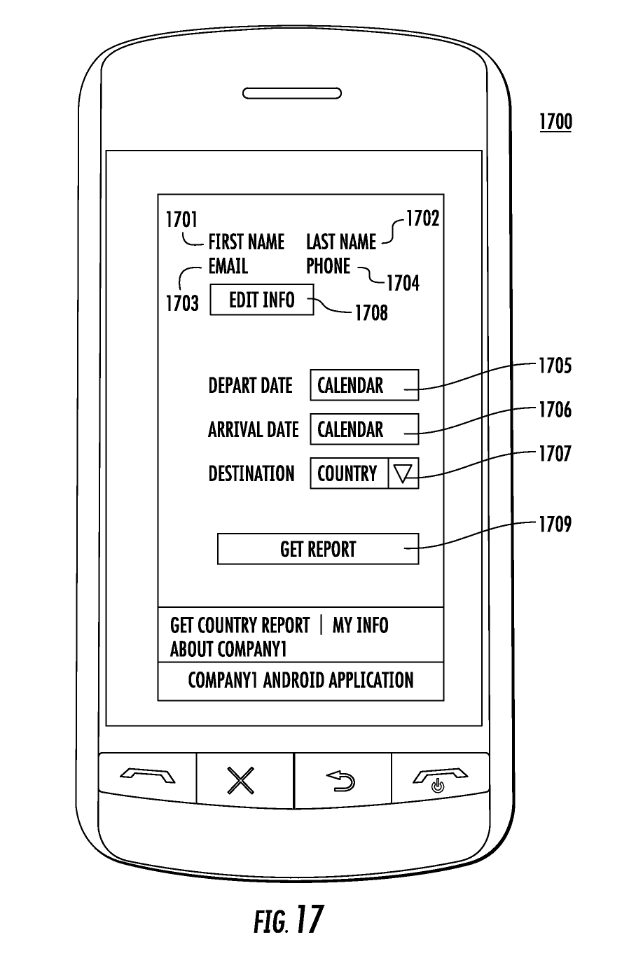

Filling in form at step 930 may include the user filling in user information in a form in the application. Filling in form 930 may include the user inputting user data including but not limited to name, address, location, e-mail, phone, travel destination and travel dates. Example forms requesting user data are illustrated in FIGS. 13 and 17.

Saving at step 940 may include saving the form information entered during step 930. This may occur automatically, periodically, or the user may manually save the form information in the application.

Displaying at step 950 may include displaying a user thank you or displaying user options. User options may include getting a destination report, finding a clinic, scheduling an appointment, ordering insurance or viewing or ordering any other travel service.

FIG. 10 illustrates an example method 1000 of using the travel preparation system. Method 1000 may include opening application 1010, opening forms 1020 (shown alternatively as 1020a and 1020b), saving form information 1030, performing search 1040, displaying report 1050, performing search 1070, clicking link 1090 and posting 1095.

Opening application 1010 may include accessing application on user device. Opening application 1010 may include activating a link or button in the application. Opening application 1010 may include clicking on a link or button for Get Destination Report.

Opening forms at step 1020a may include opening a pre-filled form. The pre-filled form may include user data and user travel related data including travel dates and travel destination that has been previously downloaded or entered. Opening forms at step 1020b may include opening a form and filling in user data and user travel related data including travel dates and travel destination.

Saving form information at step 1030 may include automatically or manually saving the form information from either the pre-filled or empty form paths. Saving form information at step 1030 may include saving information in a leads database. Saving form information at step 1030 may include creating a unique ID for the transaction.

Performing search at step 1040 may include searching travel services data based on the user travel related data including destination and travel dates. Performing search at step 1040 may include performing a clinic locator search for medical services. Performing search at step 1040 may include generating a report for the user based on the search results.

Displaying report at step 1050 may include displaying the report generated at step 1040. The report may include any travel services. The report may be a medical report. The report may be a snippet report. An example report with links to each travel service is illustrated in FIG. 14.

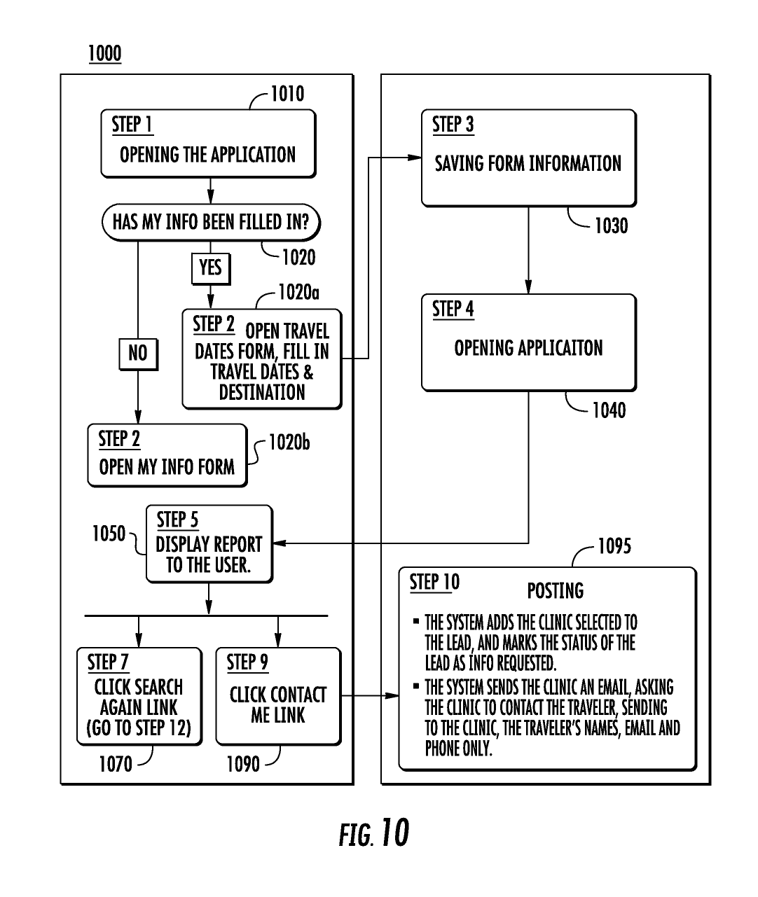

Performing search at step 1070 may include performing an additional search similar to the search performed in step 1040. Performing search at step 1070 may lead the user to further steps in the method 1100 illustrated in FIG. 11, discussed below.

Clicking or initiating link at step 1090 may include clicking a link in the generated report. The link may include a “contact me” link. The link may be a link to a website.

Posting at step 1095 may include posting unique URL identifiers to the web based on the link at step 1090. The system may add the clinic selected to a lead and mark the status of the lead as info requested. The system may send the clinic an e-mail, asking the clinic to contact the user. This may include sending user data to the clinic including but not limited to name, e-mail and phone number.

FIG. 11 illustrates an example method 1100 including a web page displayed within the example application. Method 1100 may include posting 1112, performing a search 1113 and picking 1114.

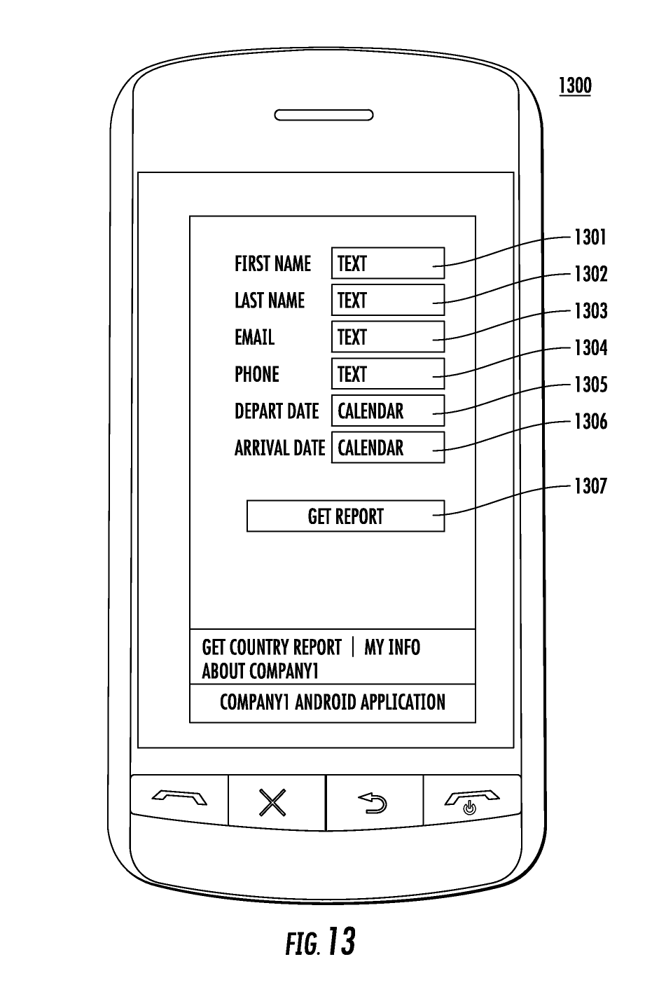

Posting at step 1112 may include posting a unique URL identifier from a link at step 1070 in FIG. 10. Posting may include opening two fields, zip code and destination. The system may obtain and retain user data via hidden fields. Example fields are illustrated in FIG. 15.

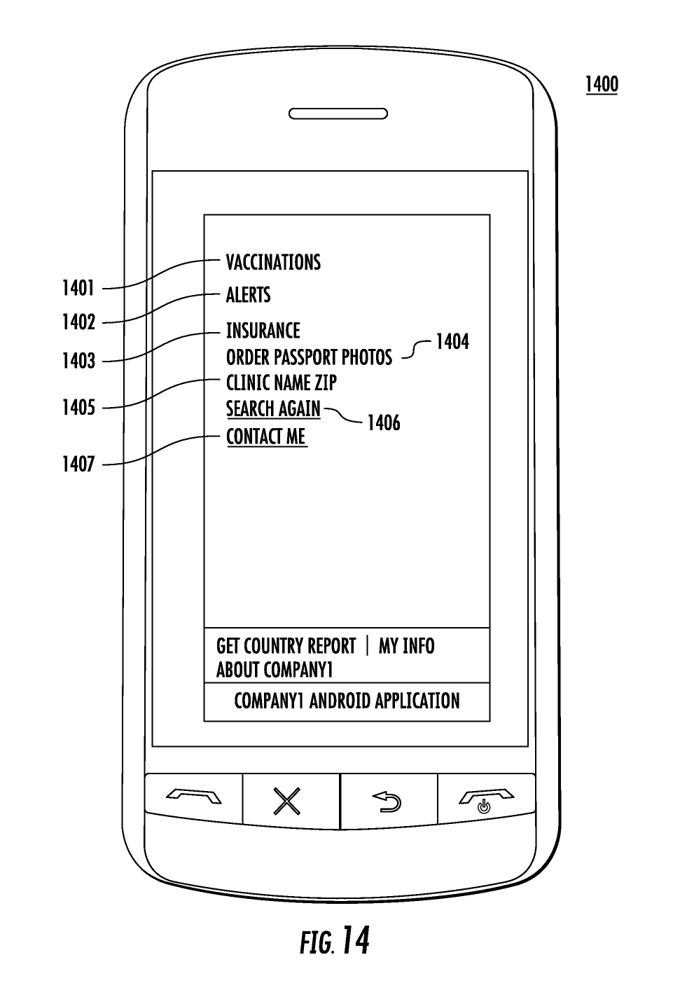

Performing a search at step 1113 may include performing a clinic search based on the zip code entered. This may allow the user to pick a clinic in step 1114. Example search results are illustrated in FIG. 16.

Picking at step 1114 may include allowing the user to pick a clinic or schedule an appointment from the search at step 1113. Picking may include selecting a clinic link. Alternatively, picking may include offering a list of clinics that the user chooses from.

FIG. 12 illustrates an example mobile application for executing the travel preparation system.

FIG. 13 illustrates an example form 1300 requesting user data. User data may include first name 1301, last name 1302, e-mail 1303, phone 1304, depart date 1305, arrival date 1306. The form may include a link or button to generate a report 1307. The report 1307 may be a travel services report. The report 1307 may be a report such as the report illustrated in FIG. 14, below.

FIG. 14 illustrates an example report 1400 with links to each travel service. Links may include vaccinations 1401, alerts 1402, insurance 1403, order passport photos 1404, clinic name 1405, search again 1406 and contact me 1407.

FIG. 15 illustrates example entry fields 1500. Example entry fields 1500 may include destination 1501 and zip code 1502. A link or button 1503 may be present to generate a report from the fields.

FIG. 16 illustrates example search results 1600. Example search results 1600 may be generated from the example entry fields 1500. Example search results 1600 may include clinic results 1601, 1602 and 1603.

FIG. 17 illustrates an example form 1700 requesting user data. User data may include first name 1701, last name 1702, e-mail 1703, phone 1704, depart date 1705, arrival date 1706 and destination 1707. Example form 1700 may include a link or button 1708 to edit user data. Example form 1700 may include a link or button 1709 to generate a report. The report may be a travel services report

FIG. 18 illustrates a block diagram of an example work flow for using the travel preparation system. In the illustrated work flow, a traveler may interact with the travel preparation system referred to as TravelCare software 1806 and databases 1802 and 1804 (collectively 1800) to obtain reports including, for example, full medical reports 1832 and snippet reports 1840, via any one of a number of different sources, including, for example, medical professionals 1848 (e.g., a corporate clinic 1816 or 1824, a hospital 1820, a student health clinic 1822, a doctor's office 1826 or a pharmacy 1816 or 1828) and businesses 1846 (e.g., a good neighbor pharmacy (GNP) 1808, an online travel agent 1810, a travel agent 1812 or passport services 1814). In other embodiments, medical professionals, businesses and other entities may interact with the TravelCare software 1806 and databases 1800 independently of a traveler to obtain medical recommendations regarding, for example, a patient's travel plans (e.g., by requesting full medical reports). A user or medical professional may link (e.g., via a link embedded in a report 1832 or 1840 or via a link provided on the display of a cellular telephone (e.g., via an application (“app”)) to a clinician that may be part of a clinic network 1838/1842 and that may provide the medical services (e.g., immunization, prescriptions and counseling) that may be suggested or required for a person traveling to a specified area of the world. Alternatively, or in addition, a lead may be offered for sale to the clinician. A consumer or medical professional may also be given the option to ask the expert (1834/1844), which is described in more detail below. If the consumer contacts the clinician (e.g., via the link) or the clinician contacts the consumer, the clinician may treat the patient (1830) and/or provide any vaccinations and/or prescriptions (1836) that the consumer may desire/require in preparation for his or her travel.

The TravelCare software 1806 may interact with databases 1802 and 1804 to create and deliver dynamic medical, safety and security reports (e.g., full medical reports or snippet reports 1832 and 1840) on destination and patient specific bases. Reports may include, for example, medical recommendations that may be used by medical professionals throughout the world. A full medical report 1832 may be very detailed and may include, for example, full details/listings of diseases that are prevalent at a travel destination, vaccinations/treatments pertaining to those diseases, recommended vaccinations for all people (regardless of travel plans), etc.

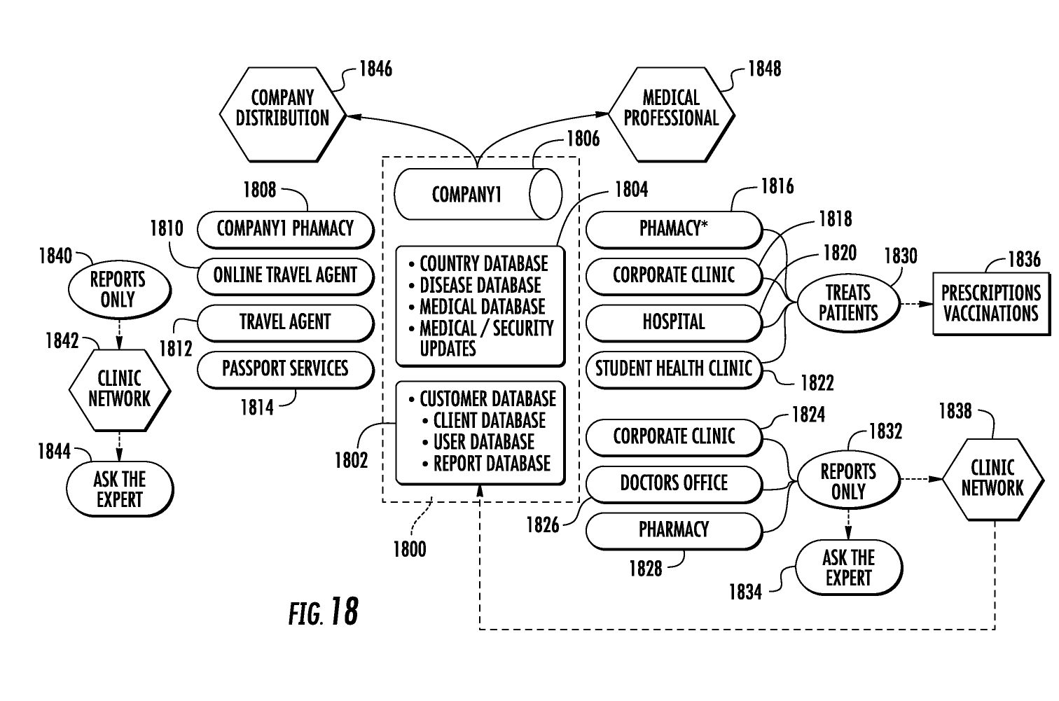

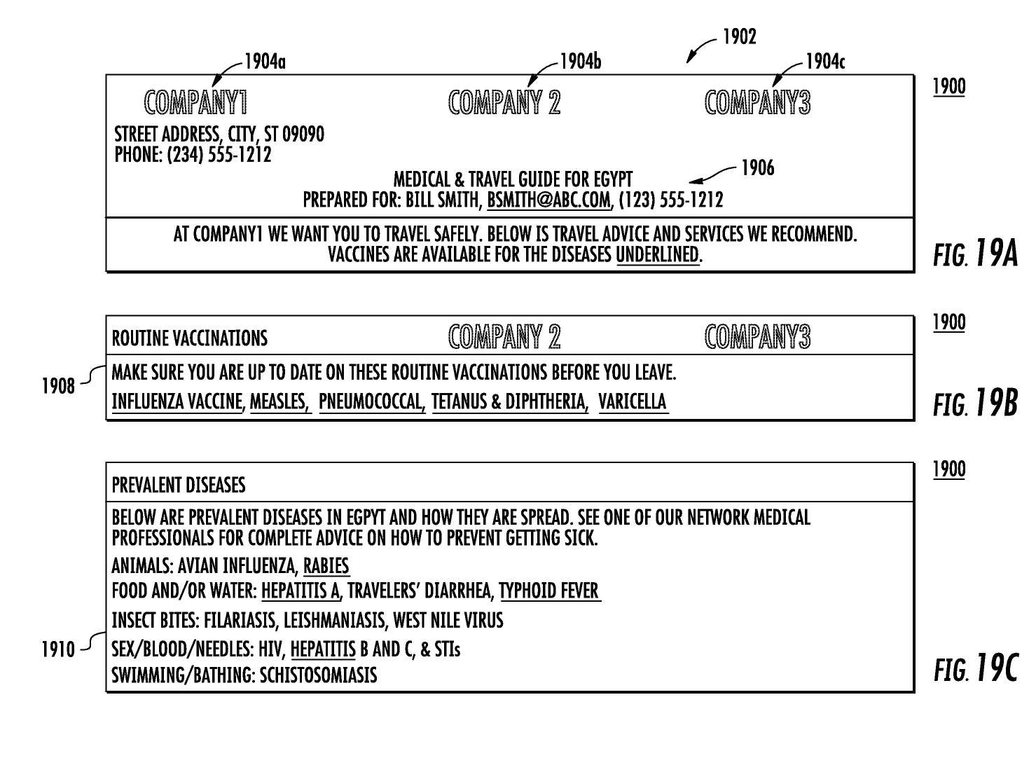

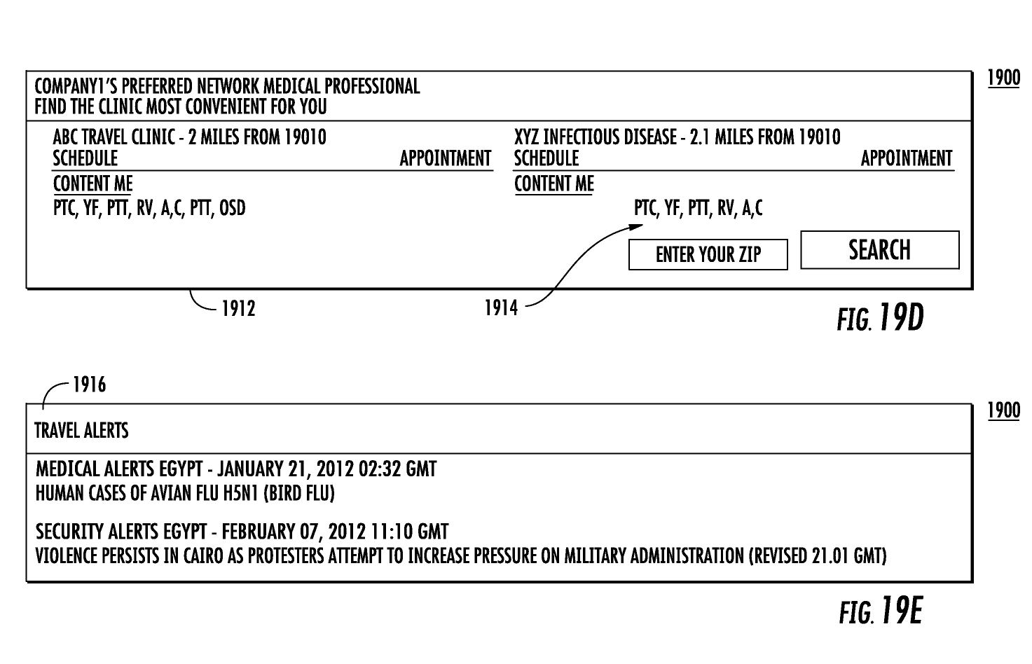

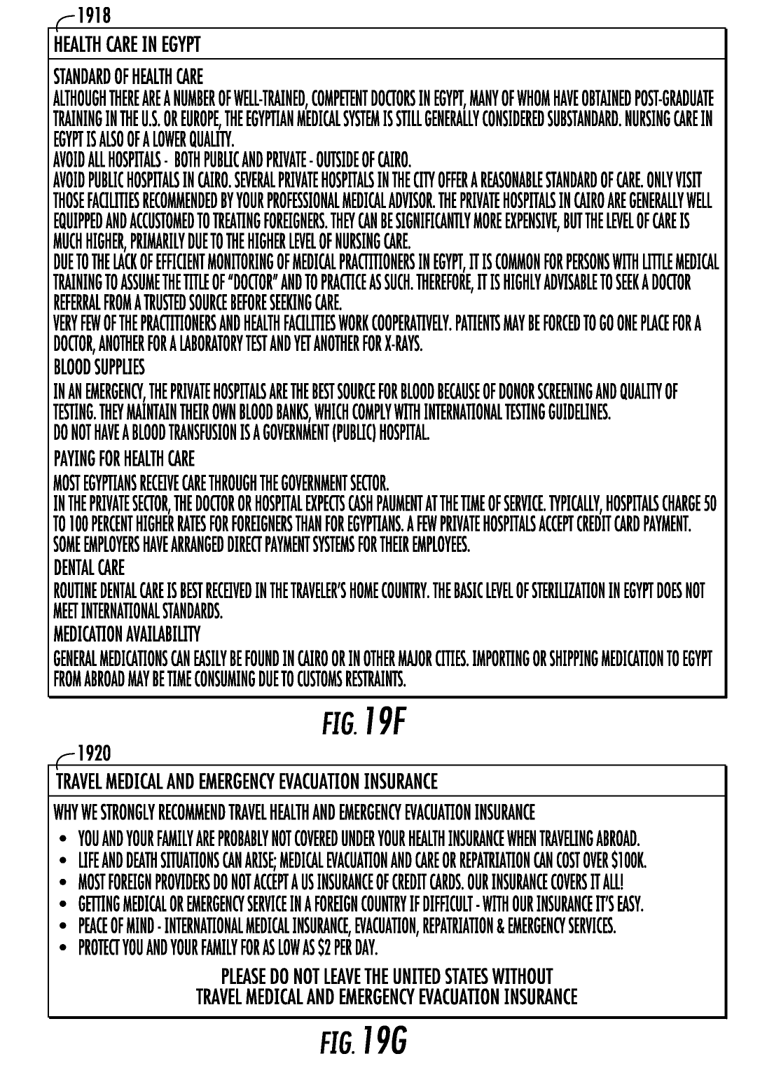

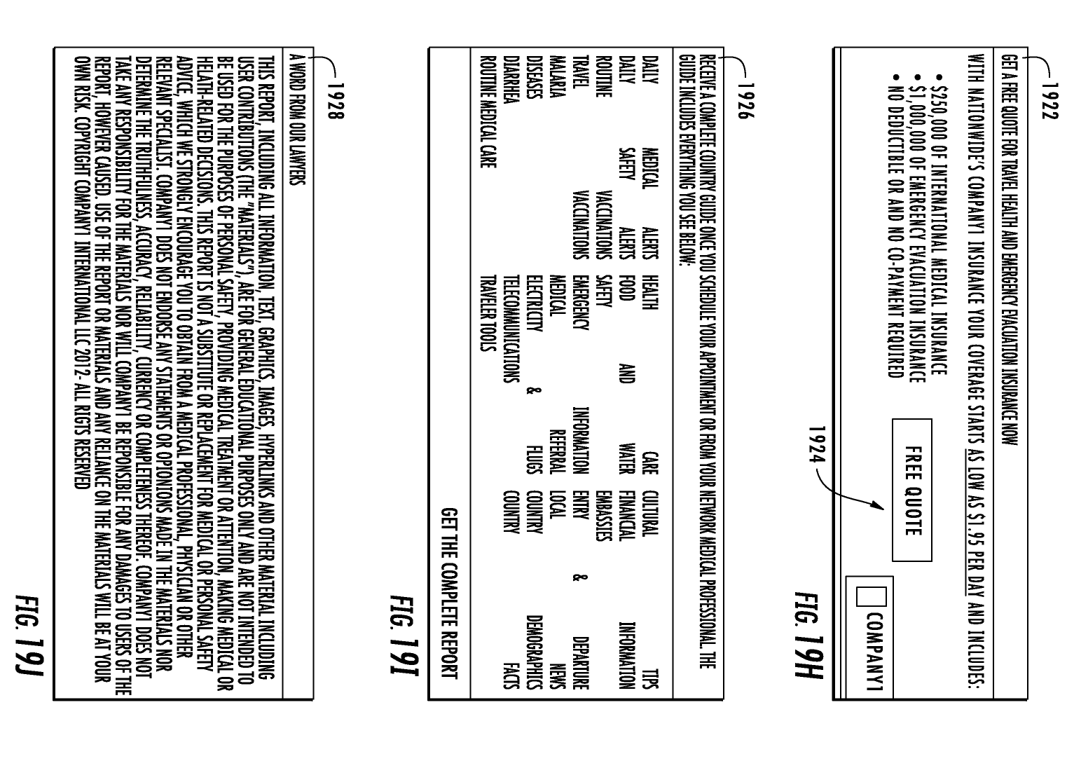

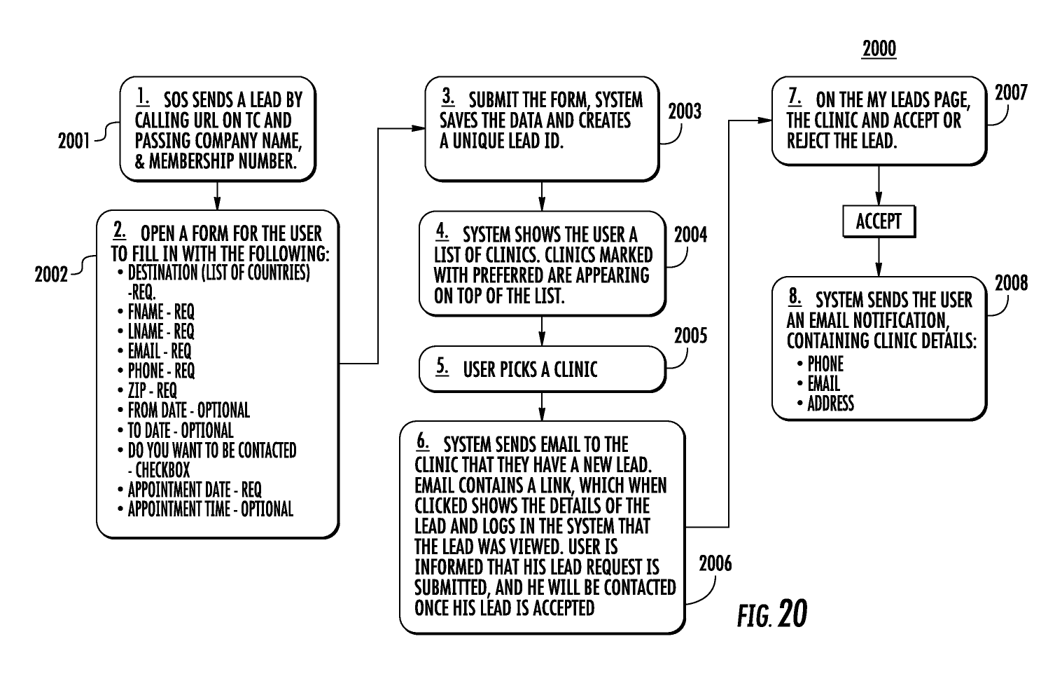

Because the full medical reports 1832 may be so detailed, a lay person may have difficulty reading and interpreting such a report. Accordingly, a snippet report 1840 may be made available, which may be useful for those who are not medical professionals, that may include a summary of the data provided in the full medical report. An example of a snippet report is illustrated in FIGS. 19A-19J. However, snippet reports may include many different formats and may include more or less detail than the example report 1900 shown in FIGS. 19A-19J. In an embodiment, a user may customize a snippet report, for example, by selecting the data he or she wants to see in the report.

In an embodiment, full medical and/or snippet reports may be customized for a particular patient/user. For example, the patient/user may enter (e.g., the an interface on an Internet webpage) information that is specific to him or her (e.g., the patient is a child, the patient is breast feeding, the patient has a cardiac condition, the patient is pregnant, the patient has a psychiatric condition, the patient is taking psychiatric medication(s), the patient has a seizure disorder, the patient is taking medication(s) for a seizure disorder, etc.). The information provided in the report and/or the list of medical professionals provided via the report may be further customized based on the entered information. For example, if a vaccine is recommended for travel to a specific travel destination but is not recommended to be given to patients who are pregnant, the report may include this information and recommend postponing travel until after the baby is born. For another example, alternative vaccinations/treatments may be recommended if available.

Reports may be delivered electronically (e.g., via fax, email or display via an Internet website) and/or print. In addition, or in place of, the databases 1802 and 104, information required to generate the reports 1832 and 1840 may be obtained from other electronic sources (e.g., other databases, the Internet, etc.).

FIGS. 19A-19J illustrate example snippet reports 1900. These reports 1900 may summarize medical, safety and security information for one of over 260 destinations worldwide. Reports 1900 may be an instant, semi-customized report generated online and delivered electronically (e.g., via email, fax, or display via an Internet website), print and/or phone (e.g., at the point of purchase). These reports 1900 may be the tool that is used to educate the consumer at the point of sale (e.g., ticket purchase, in pharmacy, supermarket, etc,) and, in addition to alerting the consumer of the medical issues, it may connect the consumer to the closest medical professional in the network. These reports may also be used as a customer acquisition tool for the retailer that uses the application. Links to purchase travel insurance products may also be embedded in the reports.

The example report 1900 illustrated in FIG. 19A includes a header 1902, which may include branding 1904a, 1904b and 1904c and captured consumer information 1906. The branding 1904a, 1904b and 1904c may include, for example, a name, contact information and logos for one or more online partners. The captured consumer information 1906 may include, for example, information about a consumer, such as first and last name, e-mail address, phone number, travel destination, dates of travel, zip code and company, which he or she or his or her medical professional may have entered via a user interface provided on an Internet website.

The example report 1900 also includes a plurality of information fields 1908 in FIG. 19B, 1910 in FIG. 19C, 1912 in FIG. 19D, 1916 in FIG. 19E, 1918 in FIG. 19F, 1920 in FIG. 19G, 1922 in FIG. 19H, 1926 in FIG. 19I and 1928 in FIG. 19J.

Referring to FIG. 19B, the information field 1908 may include information about routine vaccinations (e.g., vaccinations that may be suggested or required for all people, regardless of whether or not they are traveling).

Referring to FIG. 19C, the information field 1910 may include information about prevalent diseases in the area to which the consumer intends to travel.

Referring to FIG. 19D, the information field 1912 may include information about medical professionals that may provide required and/or suggested immunizations/treatments for the consumer. In the example illustrated in FIG. 19D, the information field 1912 includes a listing of clinics that are within a given distance of the consumer and embedded links and/or information to schedule an appointment with and/or contact the listed clinics. The illustrated information field 1912 also includes a list 1914 of designations for use by the clinics, including PTC (pre-travel consultation), YF (yellow fever), PTT (post trip travel), RV (routine vaccination), A (adult) and C (child). Other designations, such as on-site diagnostic (OSD), may also be included in the list 1914.

Referring to FIG. 19E, the information field 1916 may include information about travel alerts that have been issued for the area in which the consumer intends to travel, including, for example, medical alerts and security alerts.

Referring to FIG. 19F, the information field 1918 may include information about health care in the consumer's intended travel destination including, for example, the standard of health care at the destination, information about blood supplies at the destination, information about paying for health care at the destination, information about dental care at the destination and information about availability of medication at the destination.

Referring to FIG. 19G, the information field 1920 may include information about travel and emergency evacuation insurance including, for example, reasons why the consumer may wish to consider purchasing such insurance.

Referring to FIG. 19H, the information field 1922 may also include information about how and where to purchase travel and emergency evacuation insurance and may include an embedded link 1924 that the consumer may click to obtain a free quote on such insurance from, for example, a partner insurance company.

Referring to FIG. 19I, the information field 1926 may include information about a travel guide that may be available for the consumer's intended area of travel and an embedded link that the user may click to obtain a complete report.

Referring to FIG. 19J, the information field 1928 may include legal information that may pertain to the report.

As described above, a snippet report 1900 may include information about a clinic that may provide medical services (e.g., immunizations, counseling, etc.) that may be required or suggested for the consumer prior to travel to the intended area. In an embodiment, the recommended clinician may be part of a national clinic network (e.g., clinic network 1838/1842 illustrated in FIG. 18). For example, a national clinic network was developed that combines clinic specific data and geo-coded locations allowing a consumer who is traveling to a specific country to see a doctor that provides specific services for that country. Not all medical professionals, pharmacies, etc., stock or perform the specific vaccinations for all destinations. Accordingly, connecting a consumer with an appropriate medical provider matched to their intended travel destination may streamline the process of the consumer obtaining proper travel medical care, thus increasing the likelihood that the consumer may obtain such services. Coupons may be included with a snippet report. The inclusion of coupons may be related to the information in the report, including but not limited to user data and user travel related data. A coupon may include a discount on travel services or goods. A coupon may be a traditional print coupon, a promotional or discount code, or a bar code. The coupons may be for any travel service. Coupons may encourage the purchase of medical services with a particular service provider. Medical services may include prescription drugs, vaccinations and consultations. Travel services may include insurance or travel related supplies and services. The coupons may be based on the zip code or geo-location of the user. The coupons may be based on the travel destination or the travel details.

A snippet report 1900 or a full medical report may also include an option to “Ask the Expert,” which may include an electronic request form, embedded link and/or toll free number to contact a travel medical professional who may provide a consultation, a medical recommendation and/or a connection to the nearest treatment location (e.g., for a fee or as a part of a corporate subscription).

As described above, the TravelCare software 1806 may be used by medical professionals (e.g., infectious disease doctors, travel clinics, student health services, corporate clinics, and pharmacies). Vaccination and prescription drug inventory management may be integrated on behalf of the medical professionals and drug companies. Connecting consumers/patients with subscribing medical professionals may enable tracking of vaccination and prescription drug inventory, providing valuable data to the pharmaceutical industry.

An “app” may also be provided for the Travel Medical Passport whereby consumers and professionals may access their database and generate reports via a mobile device. Consumers may use the “app” to generate a snippet report, and medical professionals may use the app to obtain complete reports, based on their login credentials. In an embodiment, a user may access the app via his or her cellular telephone (e.g., iPhone®, Android® phone, etc.). The user may enter information such as travel destination, geographic location (e.g., zip code) and conditions (e.g., child, breast feeding, cardiac condition, pregnant, etc.), and the app may provide the user with a link to one or more recommended medical providers. In response to clicking or touching the link, the app may automatically dial, e-mail, text message, etc. the recommended provider. Thus, the user may easily contact a medical provider to set up a pre-travel appointment.

In an embodiment, the user may not need to expressly enter his or her geographic location. Instead, the app may access the user's current location (e.g., via GPS data provided via the phone's GPS unit).

Many U.S. insurance plans do not cover overseas travel. Therefore, many consumers travel abroad without medical coverage. Accordingly, serious medical issues may result in the consumer paying cash for services and receiving less than adequate medical care. Medical insurance for overseas travel is growing rapidly. Consumers that obtain the medical services suggested in a snippet report may be less likely to require medical care than consumers who do nothing, and a relationship established between the consumer and a clinician recommended in the report may result in the medical insurance companies experiencing lower loss rates and high profits.

Examples of different avenues via which a consumer may obtain snippet reports follow.

By way of example, a consumer may purchase a flight to a foreign country via an online travel agent. After the purchase, the consumer may be notified that he or she may receive a free travel medical report for their specific destination. If the consumer accepts the free report, information that was captured during the sale (e.g., name, phone, email, zip code, travel dates, destination) may be passed to the travel preparation system 100 (e.g., electronically) and a travel report may be automatically generated and electronically transmitted to the consumer (e.g., emailed, faxed, provided through an Internet website, etc.). A lead may also be sent to the closest medical clinic (e.g., a medical provider that offers services associated with the consumer's intended travel destination and is located within a given distance of the geographic location of the consumer) in the database 120 or available via an Internet search for processing. Similarly, the consumer may enter their information into an Internet website, partner, etc. and generate their own request.

By way of another example, a consumer may purchase a cruise trip via a travel agent, in person, on the phone or electronically. Upon purchase, the option of “get a free travel report” may be generated by hand, physical input by the agent or via electronic link. Leads may be tracked by source, and reports may be built and delivered electronically to the consumer and simultaneously to the closest network medical professional.

By way of another example, a consumer may visit a pharmacy. The consumer may notice “traveling overseas” marketing and ask a pharmacist or medical professional for information. Via a kiosk (e.g., a computer terminal, ipad, web-based device, or browser) or physical form, or web-based access by the pharmacy department, the consumer's basic information may be entered (e.g., first name, last name, zip code, phone number, email address, travel dates and destination). Once the information is submitted to the travel preparation system 100, a travel report or travel snippet report may be generated and delivered to the consumer and nearest medical professional (e.g., at the same time). The clinic may contact the consumer to attempt to schedule an appointment. A lead may also be sent the insurance company who may contact the consumer to buy medical health insurance, etc. Coupons may be displayed related to the destination, retailer goods and services, and travel related goods and services as well.

Each time a report is generated, user information may be captured. Based on the consumer's geographical location (e.g., zip code), several of the closest medical professionals/clinics may be displayed to the consumer (e.g., a list of one or more of the closest medical professionals to the consumer may be provided to the user in the report on an Internet website). A link may be embedded in the report for the consumer to contact one of the medical professionals/clinics and/or schedule an appointment (e.g., the consumer may click the embedded link to call or send a message to the medical professional/clinic). A lead may also be generated and electronically sent to the closest clinic that may receive, for example, an email or fax alerting them that a lead is available. The medical professional/clinician may be required to accept purchase of the lead. The lead may be electronically sent to the professional/clinician in response to receiving acceptance of purchase of the lead (e.g., via email, text message or fax). The medical professional/clinic may be responsible for paying for the lead once accepted.

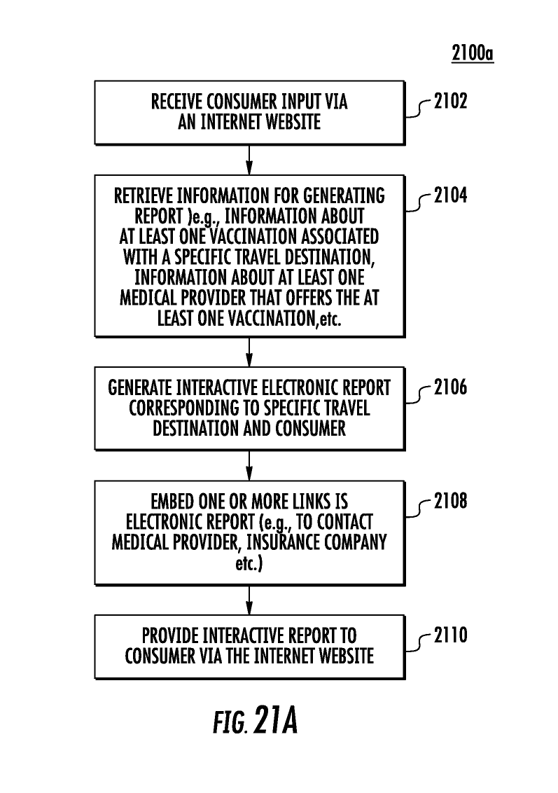

FIG. 20 illustrates a flow diagram 2000 of an example method of offering services for sale over the Internet. In the illustrated example, a consumer may have clicked on an embedded link to contact a medical professional. In response, a system may send a lead (e.g., to a medical professional) by calling a uniform resource locator (URL) and passing on information, such as company name and membership number at step 2001. Further, an electronic form may be opened on the Internet website through which the user may be prompted to enter certain information such as a travel destination (e.g., select from a list of countries), first name, last name, e-mail address, phone number, zip code, desired appointment dates and times and whether or not the consumer wishes to be contacted by the medical professional at step 2002. Some of the information may be required in order for the consumer to contact the medical professional and some may be optional. The form may be submitted, and the system may save the entered data and create a unique lead identifier (ID) for the transaction 2003.

The Internet website may show the user of a list of clinics at step 2004. In an embodiment, preferred clinics (e.g., marked as preferred in a database) may be provided at the top of the list. The consumer may select a clinic from the list at step 2005, for example, by clicking a button displayed via the Internet website. In response, the system may electronically send a notice to the clinic offering them the lead. The e-mail may include a link, which, when clicked, may show the details of the lead, and a server may log in the system that the lead was viewed at step 2006. The user may be informed that his or her lead request was submitted and that he or she will be contacted once the lead is accepted (e.g., by the clinic agreeing to purchase the lead) 2006.

The clinic may view a “My leads” page on an Internet website and accept (316) or reject the lead (e.g., by clicking a button on the Internet website) at step 2007. The system may also electronically contact the consumer to provide clinic details, such as a phone number, e-mail address, location address, etc. at step 2008.

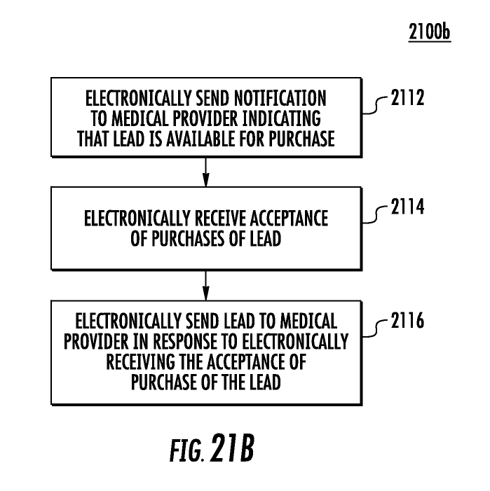

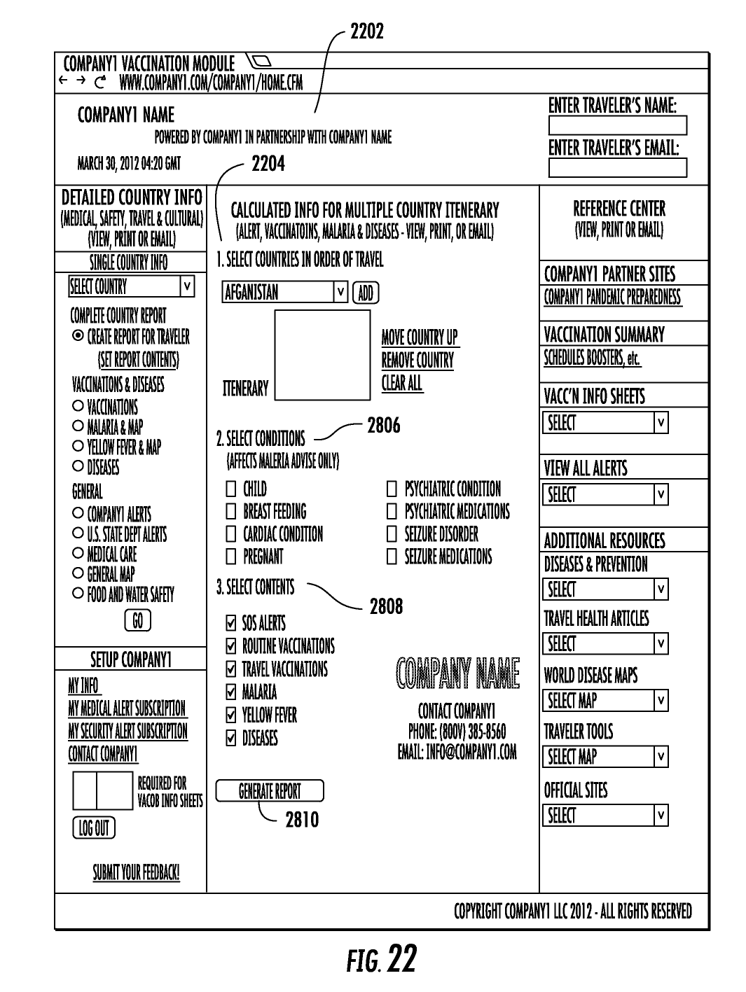

FIG. 21A is a flow diagram 2100a of another example method of offering services for sale over the Internet. A server may receive consumer input via an Internet website at step 2102. The server may retrieve information for generating a report (e.g., information about at least one vaccination associated with a specific travel destination, information about at least one medical provider that offers the at least one vaccination, etc.) at step 2104. The server may generate an interactive electronic report corresponding to a specific travel destination and consumer at step 2106 and may embed one or more links in the electronic report (e.g., to contact a medical provider, insurance company, etc.) at step 2108. The server may provide the interactive report to the consumer via the Internet website at step 2110.

FIG. 21B is a flow diagram 2100b including an example variation of the method of offering services for sale over the Internet of FIG. 21A. In the illustrated flow diagram 2100b, the server may electronically send a notification to the medical provider indicating that a lead is available for purchase at step 2112 and may electronically receive acceptance of the purchase of the lead at step 2114. The server may electronically send the lead to the medical provider in response to receiving the acceptance of the purchase of the lead at step 2116.

FIG. 22 is a diagram of an example user interface 2200 for entering information via an Internet webpage. The illustrated user interface 2200 may be accessed by entering a URL address into a web browser at step 2202. The illustrated interface includes a drop down menu via which a user may select one or more countries at step 2204, a plurality of conditions at step 2206 that a user may select from and specific content at step 2208 that a user may select to receive information about. Although not shown, the user interface may also include a field for entering a geographic location of the users (e.g., zip code), although this field is not required because the user's geographic location may be obtained by other methods (e.g., using GPS data, using a home address previously entered by the user, etc.). The information entered via the user interface at step 2200 may be used to generate a snippet and/or full medical report, for example, in response to the user clicking/touching a “generate report” button at step 2210.

The system or method may include an additional feature that allows a medical professional to “register” their patient/traveler information. Registering may include entering the patient/traveler information into an application or form. This information may include but is not limited to first and last name, phone numbers, e-mail address, destination, and dates of travel. When a report is generated a customized (to the traveler) snippet report or medical report may be delivered via print, fax or e-mail or other electronic distribution. The registration may allow the medical professional to track their patients in a section of the system that may be denoted as “my leads.”

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

As used herein, the term “processor” broadly refers to and is not limited to a single- or multi-core central processing unit (CPU), a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although features are described herein as being performed in a tablet computing device, the features described herein may also be implemented, mutatis mutandis, on a desktop computer, a laptop computer, a netbook, a cellular phone, a personal digital assistant (PDA), or any other appropriate type of tablet computing device or data processing device.

Although features and elements are described above in particular combinations, each feature or element can be used alone or in any combination with or without the other features and elements. For example, each feature or element as described above may be used alone without the other features and elements or in various combinations with or without other features and elements. Sub-elements of the methods and features described above may be performed in any arbitrary order (including concurrently), in any combination or sub-combination.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

Any single embodiment herein may be supplemented with one or more elements from any one or more other embodiments herein. It is understood, therefore, that this invention is not limited to the particular embodiments disclosed, but is intended to cover all modifications which are within the spirit and scope of the invention as defined by the appended claims; the above description; and/or shown in the attached drawings.

What is claimed:

1. A travel preparation system comprising:
a database including a plurality of user data and a plurality of travel preparation data;
a communication interface that receives data from at least one user device, the received data including user travel related data;
a processor that accesses the database based on the received data and identifies travel services to offer including at least one of passport services or medical preparation services, wherein the identified travel services are provided to the at least one user device via the communication interface.

2. The system of claim 1, wherein the plurality of user data includes at least one of a user's name, address, location, telephone number, e-mail, and payment information.

3. The system of claim 2, wherein the plurality of user data further includes at least one of a user's age, medical history, medications, mental illnesses, and disorders.

4. The system of claim 1, wherein the plurality of travel preparation data includes at least one of passport data, medical preparation data, travel insurance data, travel reservation data, and travel guide data.

5. The system of claim 4, wherein passport data includes passport photo provider information.

6. The system of claim 4, wherein medical preparation data includes vaccination requirements, medical guidance, diseases, preventative medications, and medical providers.

7. The system of claim 4, wherein travel insurance data includes travel insurance options and travel service providers.

8. The system of claim 4, wherein travel reservation data includes at least one of a hotel reservation, a car reservation, or a flight reservation.

9. The system of claim 4, wherein travel guide data includes destination specific information.

10. The system of claim 1, wherein user travel related data includes a travel destination.

11. The system of claim 1, wherein passport services include at least one passport photo provider selected from the plurality of travel preparation data based on the user data and the user travel related data.

12. The system of claim 1, wherein medical preparation services include a medical report generated from the plurality of travel preparation data based on the user data and the user travel related data.

13. The system of claim 1, wherein medical preparation services include a snippet report generated from the plurality of travel preparation data based on the user data and the user travel related data.

14. The system of claim 1, wherein the travel services includes at least one of travel insurance services, travel guide services or travel reservations services selected from the plurality of travel preparation data based on the user data and the user travel related data.

15. A method of offering services for sale over the Internet, the method comprising:
receiving via a communication interface travel related data and user data;
identifying user travel services including at least one of passport services or medical preparation services based on the travel related data and the user data using a processor; and
retrieving by a processor information from a database about travel services associated with the travel related data and user data.

16. The method of claim 15, wherein travel related data includes at least one of a travel destination and a travel date.

17. The method of claim 16, wherein the user data includes at least one of a user's name, address, location, telephone number, e-mail, and payment information.

18. The method of claim 17, wherein the plurality of user data further includes at least one of a user's age, medical history, medications, mental illnesses, and disorders.

19. The method of claim 15 wherein passport services include at least one passport photo provider selected from the travel related data and the user data.

20. The method of claim 15, wherein medical preparation services includes a medical report generated from the travel related data and the user data.

21. The method of claim 15, wherein medical preparation services includes a snippet report generated from the travel related data and the user data.

22. The method of claim 15, wherein travel services further include at least one of travel insurance services, travel guide services or travel reservations services based on the travel related data.

23. The method of claim 15 further comprising generating leads based on the travel related data and the user data.

24. A computer readable medium having processor-executable instructions stored thereon which, when executed by at least one processor, cause the at least one processor to perform the following method:
receiving travel related data and user data;
identifying user travel services including at least one of passport services or medical preparation services based on the travel related data and the user data; and
retrieving information about travel services associated with the travel related data and user data.

25. The method of claim 24, wherein travel related data includes at least one of a travel destination and a travel date.

26. The method of claim 24, wherein the user data includes at least one of a user's name, address, location, telephone number, e-mail, and payment information.

27. The method of claim 26, wherein the plurality of user data further includes at least one of a user's age, medical history, medications, mental illnesses, and disorders.

28. The method of claim 24 wherein passport services include at least one passport photo provider selected from the travel related data and the user data.

29. The method of claim 24, wherein medical preparation services includes a medical report generated from the travel related data and the user data.

30. The method of claim 24, wherein medical preparation services includes a snippet report generated from the travel related data and the user data.

31. The method of claim 24, wherein travel services further include at least one of travel insurance services, travel guide services or travel reservations services based on the travel related data.

32. The method of claim 24 further comprising generating leads based on the travel related data and the user data.
